(19) United States
(12) Patent Application Publication
(10) Pub. No.: US 2013/0125161 A1
(43) Pub. Date: May 16, 2013

(54) AWARDS AND ACHIEVEMENTS ACROSS TV ECOSYSTEM

(71) Applicants: Tim Herby, Los Altos, CA (US); Antonio Fontan, San Jose, CA (US); Chris Welden, Mountain View, CA (US)

(72) Inventors: Tim Herby, Los Altos, CA (US); Antonio Fontan, San Jose, CA (US); Chris Welden, Mountain View, CA (US)

(73) Assignee: MICROSOFT CORPORATION, Redmond, WA (US)

(21) Appl. No.: 13/298,208

(22) Filed: Nov. 16, 2011

(51) Int. Cl. H04N 7/16

(52) U.S. Cl. 725/23

(57) ABSTRACT

Embodiments for awarding a user are provided. In one example embodiment, a method for awarding a user comprises receiving a user-viewing goal detailing a specific linear video content viewing behavior of the user. The method also includes receiving one or more user-specific reports of all linear video content viewing behaviors of the user while using each of a plurality of different applications, and granting an award to the user if the user-specific reports collectively indicate the user-viewing goal is reached by the user.

### BACKGROUND

Traditional television viewing experiences tend to be passive, and do not frequently provide opportunities for a viewer to engage with the programming. Additionally, with the proliferation of digital video recording devices, advertisers are finding it increasingly difficult to introduce their advertisements to viewers.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for awarding a user is provided. The method comprises receiving a user-viewing goal detailing a specific linear video content viewing behavior of the user. The method also includes receiving one or more user-specific reports of all linear video content viewing behaviors of the user while using each of a plurality of different applications, and granting an award to the user if the user-specific reports collectively indicate the user-viewing goal is reached by the user.

### BRIEF DESCRIPTION OF THE DRAWINGS

FIG. 1 shows a non-limiting example of linear video content viewing environment.

FIG. 2 is a flow chart illustrating a method for awarding a user according to an embodiment of the disclosure.

FIG. 3 is a flow chart illustrating a method for awarding a user according to another embodiment of the disclosure.

FIG. 4 schematically shows an example award system according to an embodiment of the present disclosure.

FIG. 5 schematically shows a non-limiting computing system.

### DETAILED DESCRIPTION

Television viewing tends to be a passive experience for a viewer, without many opportunities for the viewer to engage or have interactive experiences with the presented content. To increase interactive viewing and encourage a user to watch one or more particular items of video content, awards and achievements may be tied to those items of video content. Producers, distributors, and advertisers of the video content may set viewing goals and award a viewer who has reached the goals. By providing content viewing goals and awarding the viewer for reaching the goals, the present disclosure provides for an interactive television viewing experience. Additionally, by tying the awards and achievements to particular items of video or advertising content, viewers may be encouraged to increase their viewership of the content, thus increasing advertising opportunities.

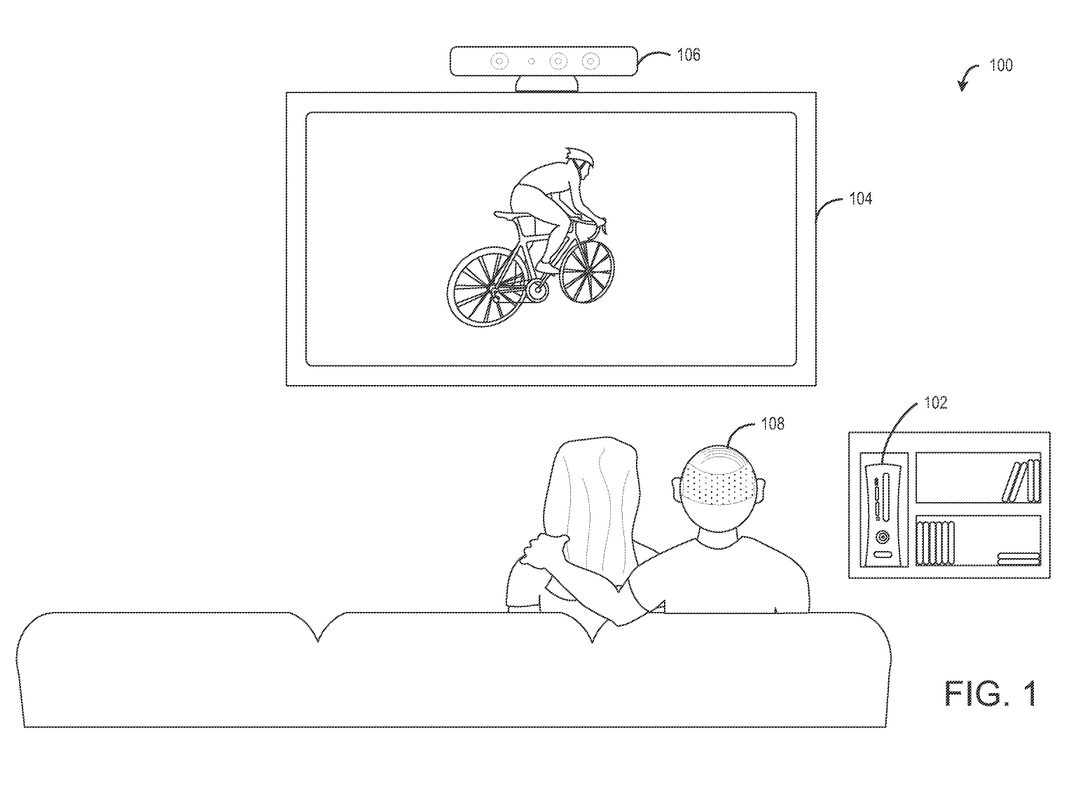

FIG. 1 shows a non-limiting example of linear video content viewing environment 100 in the form of a computing system 102, a display device 104, and one or more optional sensors 106. The display device 104 may be operatively connected to the computing system 102 via a wireless or wired display output of the computing system. For example, the computing system may include an HDMI or other suitable display output. The display device 104 as shown in FIG. 1 is in the form of a high definition television, which may be used to present linear video content to a viewer 108.

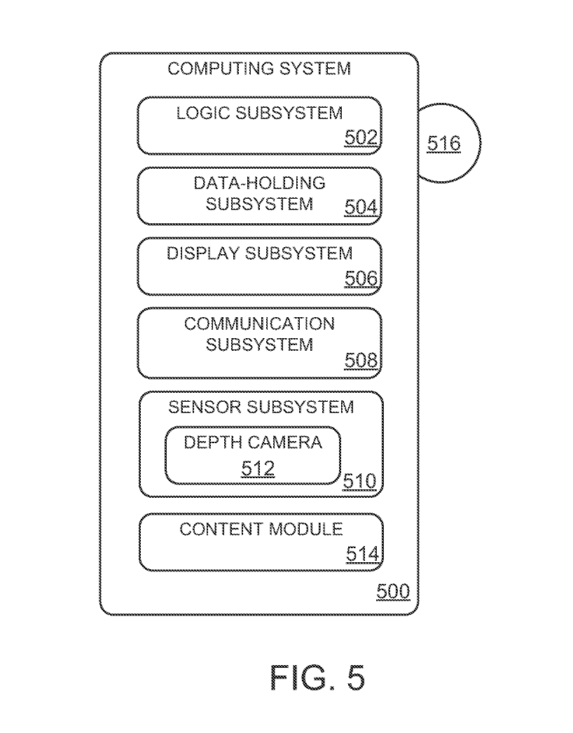

As used herein, linear video content refers to video content that progresses with a predetermined storyline from beginning to end, and may include television programming, movies, etc. Linear video content differs from nonlinear content, such as interactive video games, in which the actions of a user continuously change the storyline of the content. Linear video content may be presented in a live broadcast (e.g., in real time), presented on-demand, and/or recorded for time-shifted playback after broadcasting. While linear video content is capable of progressing without navigational control, it is to be understood that linear video content can be paused, rewound, fast forwarded, and/or otherwise navigationally controlled. However, such navigational control does not change the predetermined storyline of the linear video content, but instead changes the order and/or timing in which the viewer watches the different portions of the predetermined story. The computing system 102 may receive linear video content via a satellite feed, cable feed, over-the-air broadcast, a network (e.g., the Internet), or any other suitable video delivery mechanism. More detailed information regarding the computing system will be presented with respect to FIG. 5.

In addition to presenting linear video content, the linear video content viewing environment 100 may facilitate awarding the viewer 108 for satisfying one or more user-viewing goals. These user-viewing goals may be associated with the linear video content presented to the viewer 108. A user-viewing goal may be developed by any number of different entities, including but not limited to the creators, advertisers, producers, etc. of the linear video content. The user-viewing goals may include one or more predefined viewing behaviors set by a creator of the user-viewing goal.

The viewing behaviors may include the viewer 108 watching an item of linear video content, or watching a combination of items of linear video content. Additionally, the viewing behavior may include an action performable by the viewer 108 and detectable by one or more sensors 106, such as a depth camera.

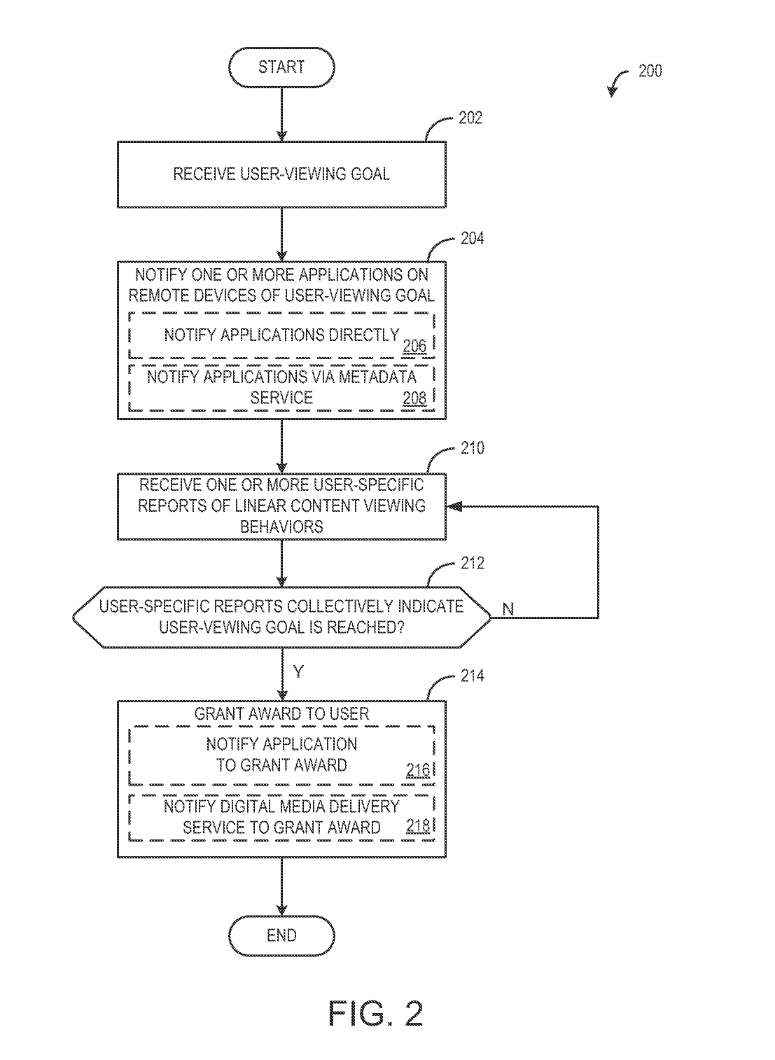

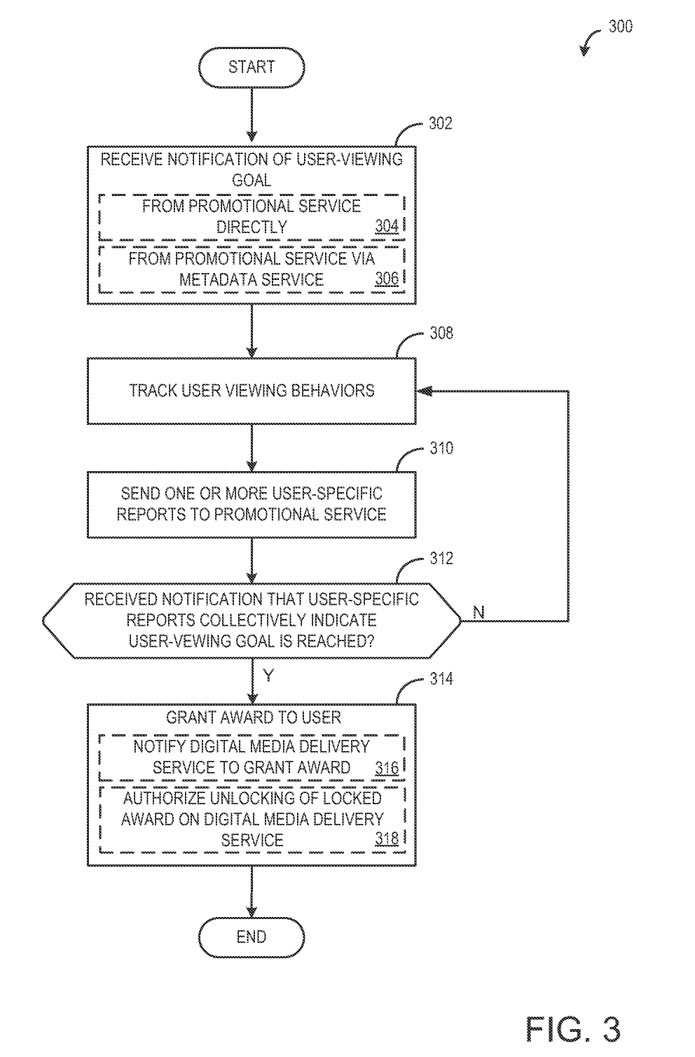

The computing system 102 may be configured to track the viewing behaviors of one or more viewers. The computing system 102 may then compile one or more user-specific reports of the viewing behaviors, and send the user-specific reports to a remote device to determine whether the user-viewing goal has been met. If the viewing goal has been met, an award may be granted to the viewer. An award may be a virtual award, such as an addition to a viewer score or an update to an avatar associated with the viewer 108. In other embodiments, the award may be physical, such as coupons for an advertised product or service, or an actual product. More information regarding rewarding the viewer will be presented below with respect to FIGS. 2 and 3.

One example user-viewing goal may include awarding the viewer 108 for watching a broadcast of each episode of a multi-episode series. The computing system 102 may track the viewing behavior of the viewer 108, and if the viewer 108 watches all episodes of the multi-episode series, the viewer 108 may be granted an award, such as a new bicycle for an avatar of the viewer 108.

The computing system 102 may be configured to communicate with one or more remote computing devices, not shown in FIG. 1, in order to execute an award. As explained above, the computing system 102 may receive linear video content directly from a broadcaster, or may receive linear video content through a third party, such as a digital media delivery service. The details of the user-viewing goal may be contained within the video content received from the broadcaster or digital media delivery service. In some embodiments, additional information may be received from other devices in communication with the computing system 102, such as devices used by creators of the user-viewing goals. For example, these devices may include a promotional service that directs the execution of the awards. The promotional service may also communicate with the computing system 102 to receive the user-specific reports from the computing system 102, and/or to notify the computing system 102 that the user-viewing goal has been met.

FIG. 2 depicts a method 200 for awarding a user. Method 200 may be executed by one or more devices in communication with the computing system 102, such as a remote server computer implementing a promotional service.

At 202, method 200 includes receiving a user-viewing goal. The user-viewing goal may be received as virtually any kind of data, instruction, or other computer understandable information. The user-viewing goal may detail a specific linear video content viewing behavior of the user. The user-viewing goal may be defined by one or more entities associated with the linear video content, such as a producer, creator, or distributor of the linear video content, an advertiser, etc. The specific linear video content viewing behavior of the user detailed by the user-viewing goal may include any suitable behavior that may be taken by the user with respect to the specific linear video content. For example, in one embodiment, the viewing behavior may include the user watching an episode of the linear video content. In some embodiments, watching an episode includes watching the only episode of single-episode content, such as the Super Bowl.

In another embodiment, the viewing behavior may include the user watching a specific plurality of episodes of the linear video content (e.g., an entire series of the linear video content), or the viewing behavior may include the viewer watching one or more commercials contained within the linear video content.

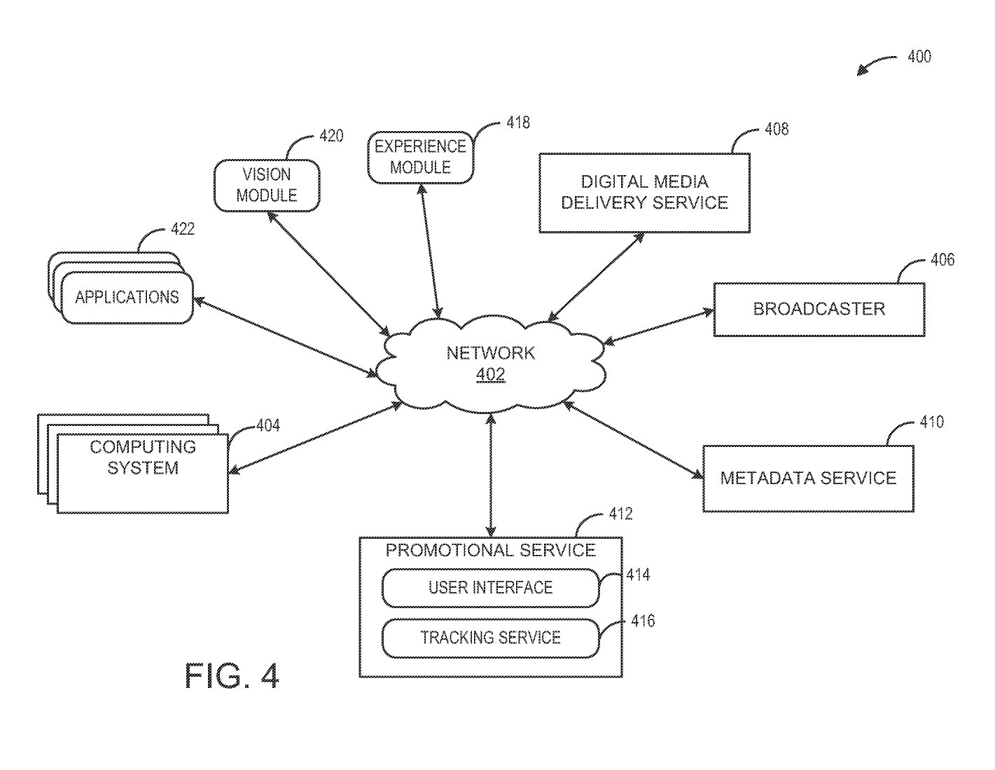

Another example viewing behavior includes the viewer performing a specific action while watching the linear video content. In such a case, the actions taken by the viewer may be sensed by a sensor, such as sensor 106. For example, the viewer may display a product that is imaged by a camera, and the computing system 102 may identify the product. In another example, the viewer simply being present, as detected by the sensor, may constitute an action taken. More information regarding sensing actions of the viewer will be described below with respect to FIGS. 4 and 5.

Method 200 includes, at 204, notifying one or more applications of the user-viewing goal. The applications may be included on or associated with a remote device, such as the computing system 102. As explained with respect to FIG. 1, the computing system 102 is configured to deliver linear video content to the viewer via a variety of sources, such as a satellite feed, over the Internet, etc. Furthermore, a user may consume content via different services, even when such services are delivered via the same source (e.g., two or more different Internet television services). The linear video content from the different sources and services may be presented by the computing system 102 via a plurality of different applications executed on the computing system 102. Example applications include video-on-demand applications, cable television modules, etc. These applications may receive notice from the promotional service that a user-viewing goal is associated with the linear video content received through that application. In doing so, the applications can notify the user that a user-viewing goal is available, for example by displaying the user-viewing goal on the display device along with the linear video content.

Notifying the one or more applications of the user-viewing goal may include notifying the one or more applications directly at 206. In some embodiments, the promotional service may receive a request from the application to send user-viewing goals related the linear video content, and as a result the promotional service may notify the application of the user-viewing goal.

Notifying the one or more applications of the user-viewing goal may include notifying the one or more applications via a metadata service at 208. A metadata service may communicate with the promotional service to receive information about the user-viewing goals, and may include the user-viewing goals in the metadata it sends to the computing system 102. The metadata may include additional information to accompany linear video content, such as the title of the content, year the content was produced, actors performing the content, etc. In this way, the applications may automatically be notified through the metadata service of user-viewing goals.

The user-viewing goals may be pushed to the one or more applications without a request from the applications, or the user-viewing goals may be made accessible so that an application can pull the user-viewing goals at the initiative of that application. In some embodiments, each application may process user-viewing goals independently of other applications. In other embodiments, a computing system may include a system-wide goal service, which all applications can interact with via an application programming interface or other suitable mechanism.

Method 200 includes, at 210, receiving one or more user- specific reports of all linear video content viewing behaviors of the user while using each of a plurality of different applications. In some embodiments, the user-specific reports include viewing behaviors of the user across a plurality of devices. The user-specific reports of linear content viewing behaviors may be received from any device on which the user watches linear video content. For example, a user may watch linear video content on a television, computer, and mobile phone, and each of these devices may be configured to track the viewing behavior of the user and send a user-specific report to the promotional service (e.g., via a common user identification).

In some embodiments, each device may compile a report that includes all viewing behaviors of the user across all applications on that device. In other embodiments, each device may compile a separate report for the viewing behaviors of the user for each application. In another embodiment, each device may notify the promotional service of every instance of a viewing behavior, and the reports may be compiled at the promotional service. In a further embodiment, each application may be configured to track the viewing behaviors across all user devices that include that application, and each application may send a report that includes the viewing behavior from all devices of the user.

The reports may be aggregated by the promotional service and collectively used to determine if the user-viewing goal has been met. Thus, at 212, method 200 includes determining if the one or more user-specific reports collectively indicate the user-viewing goal has been reached. If the user-specific reports do not indicate the user-viewing goal has been met, method 200 returns to 210 to continue to receive the one or more user-specific reports. If it is determined at 212 that the user-viewing goal has been met, method 200 proceeds to 214 to grant a physical and/or virtual award to the user. Granting the award may be done by the remote service itself, or granting the award may include indicating to another system that the award should be granted. For example, the promotional service itself may not be configured to grant the award. As such, granting an award to the user may include notifying an application to grant the award at 216. Alternatively or additionally, granting the award to the user may include notifying a digital media delivery service to grant an award to the user at 218.

The awards granted to the user for reaching the one or more user-viewing goals may be virtual awards. For example, the award may be an increase in a viewer score associated with the user. A viewer score may be a compilation of all or a subset of user-viewing goals reached by the user, and may be stored with profile information of the user. Other users may be able to access the user's viewer score, thus creating an incentive for each user to increase his or her viewer score. In another example, the award may be an update to an avatar associated with the user. An avatar may be a virtual representation of the user that may interact with other avatars. Example updates to an avatar include new outfits for the avatar, new vehicles for the avatar, new homes for the avatar, virtual money to purchase different avatar items, clothes, etc.

As these examples of awards are virtual, and not physically given to the viewer, they may be locally and/or remotely stored as computer readable information. Such computer readable information may be associated with user profile information so that the user can access and/or otherwise enjoy the award using one or more computing devices.

However, in some embodiments, physical awards may be granted. Such physical awards may include coupons, products, etc., given to the user. To grant a physical award, an entity associated with the user-viewing goal, such as a user-viewing goal creator, may be notified in order to grant the award. In other embodiments, a remote computing device which stores user profile information, such as the digital media delivery service, may be notified to grant the award. Upon granting the award, method 200 ends.

Turning to FIG. 3, a method 300 for awarding a user according to another embodiment of the present disclosure is illustrated. Method 300 may be carried out by a device configured to receive linear video content for display to a viewer, such as computing system 102. Method 300 comprises, at 302, receiving notification from a promotional service of a user-viewing goal. As explained above with respect to FIG. 2, the user-viewing goal details a specific linear content viewing behavior performable by a user. The promotional service may receive information regarding the user-viewing goal from one or more entities associated with the linear video content, and send the user-viewing goal directly at 304. In other embodiments, the user-viewing goal may be received from the promotional service via a metadata service at 306.

At 308, method 300 comprises tracking user viewing behaviors of the linear video content. These tracked viewing behaviors can be compiled into one or more reports and sent to the promotional service. Thus, at 310, method 300 includes sending to the promotional service one or more reports of linear content viewing behaviors performed by the user while using each of a plurality of different applications. As explained with respect to FIG. 2, the reports are usable by the promotional service to determine if the user-viewing goal is met.

In other embodiments, tracking the user viewing behavior may include receiving observation information from one or more sensors and using the observation information to interpret the actions of the user. The interpretation, which may indicate which actions the user performed while carrying out the user-viewing goal, may be sent to the promotional service and used by the promotional service to determine if the user-viewing goal has been met. However, it is also possible for the computing device coupled to the sensor to make the determination of whether the user-viewing goal has been met without sending the interpretation to the promotional service.

At 312, it is determined if notification has been received from the promotional service that the user-viewing goal has been met. If not, method 300 returns to 308 to continue tracking user viewing behaviors. If notification has been received, method 300 proceeds to 314 to grant an award to the user for meeting the user-viewing goal. Granting the award to the user may include notifying a remote device, such as the digital media delivery service, to grant the award at 316. Additionally or alternatively, granting the award may include authorizing the unlocking of an award that has been previously locked. For example, a digital award may be downloaded, but access to the award can be blocked until authorization to unlock the award is received. Upon granting the award to the user, method 300 ends.

FIG. 4 shows an example award system 400 according to an embodiment of the present disclosure. The award system 400 may facilitate the execution of user-viewing goals associated with linear video content, as described above. In FIG. 4, the devices and modules of the award system 400 are depicted separate from one another, and each may communicate with other devices via a network 402. However, in some embodiments, two or more of the devices and/or modules may be integrated. It is to be understood that the devices depicted in FIG. 4 can be any suitable computing device, and the modules may be hardware or software modules capable of executing on one or more suitable computing devices.

The award system 400 includes one or more computing systems 404 that are configured to receive linear video content from one or more sources, such as broadcaster 406. The computing system 404 may also receive linear video content from a digital media delivery service 408. The computing system 404 may include one or more applications 422 configured to present the linear video content from the different sources and services. Computing system 102 of FIG. 1 is a nonlimiting example of such a computing system.

In some embodiments, the user-viewing goal information may be sent from a metadata service 410, as described above with respect to FIG. 2. The metadata service 410 may be included in the digital media delivery service 408, or may be included in a device belonging to a broadcaster 406.

One or more creators of a user-viewing goal may register the user-viewing goal with a promotional service 412 via a user interface 414. The details and conditions of the user-viewing goal may be stored on the promotional service 412. The promotional service 412 may send the user- viewing goal to the computing system 404 in order to initiate the user- viewing goal. The user-viewing goal information can be sent directly from the promotional service 412 to the computing system 404, or it can be sent via the digital media delivery service 408, the metadata service 410, or the broadcaster 406.

The promotional service 412 may include a tracking service 416. The tracking service 416 may receive the one or more user-specific reports from computing system 404. The tracking service 416 may collectively assess the one or more user-specific reports to determine if the user-viewing goal has been met.

In embodiments where the user-viewing goal includes the user performing an action, an experience module 418 associated with the computing system 404 may launch. The experience module 418 may be configured to receive information regarding one or more conditions of the user-viewing goal, receive observation information from one or more sensors, and interpret the observation information. The experience module 418 may further be configured to send the interpretation to the promotional service 412. A vision module 420 may assist the experience module 418 in interpreting the received observation information. The vision module 420 may be configured to recognize objects displayed by the viewer, determine which actions the viewer is performing, etc. While shown separately in the depicted embodiment, the experience module 418 and the vision module 420 may be integrated as part of the computing system 404.

In some embodiments, the above described methods and processes may be tied to a computing system including one or more computers. In particular, the methods and processes described herein may be implemented as a computer application, computer service, computer API, computer library, and/or other computer program product.

FIG. 5 schematically shows a nonlimiting computing system 500 that may perform one or more aspects of the above described methods and processes. Computing system 102 of FIG. 1 is a nonlimiting example of such a computing system. Furthermore, promotional service 412, digital media delivery service 408, metadata service 410, and broadcaster 406 of FIG. 4 may be configured similarly to computing system 500. Computing system 500 is shown in simplified form. It is to be understood that virtually any computer architecture may be used without departing from the scope of this disclosure. In different embodiments, computing system 500 may take the form of a mainframe computer, server computer, desktop computer, laptop computer, tablet computer, home entertainment computer, network computing device, mobile computing device, mobile communication device, gaming device, etc.

Computing system 500 includes a logic subsystem 502 and a data-holding subsystem 504. Computing system 500 may optionally include a display subsystem 506, communication subsystem 508, and/or other components not shown in FIG. 5. Computing system 500 may also optionally include user input devices such as keyboards, mice, remote controllers, game controllers, cameras, microphones, and/or touch screens, for example.

Logic subsystem 502 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 504 may include one or more physical, non-transitory, devices configured to hold data and/or instructions executable by the logic subsystem to implement the herein described methods and processes. When such methods and processes are implemented, the state of data-holding subsystem 504 may be transformed (e.g., to hold different data).

Data-holding subsystem 504 may include removable media and/or built-in devices. Data-holding subsystem 504 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 504 may include devices with one or more of the following characteristics: volatile, nonvolatile, dynamic, static, read/write, read-only, random access, sequential access, location addressable, file addressable, and content addressable. In some embodiments, logic subsystem 502 and data-holding subsystem 504 may be integrated into one or more common devices, such as an application specific integrated circuit or a system on a chip.

FIG. 5 also shows an aspect of the data-holding subsystem in the form of removable computer-readable storage media 516, which may be used to store and/or transfer data and/or instructions executable to implement the herein described methods and processes. Removable computer-readable storage media 516 may take the form of CDs, DVDs, HD-DVDs, Blu-Ray Discs, EEPROMs, and/or floppy disks, among others.

It is to be appreciated that data-holding subsystem 504 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of computing system 500 that is implemented to perform one or more particular functions. In some cases, such a module, program, or engine may be instantiated via logic subsystem 502 executing instructions held by data-holding subsystem 504. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, display subsystem 506 may be used to present a visual representation of data held by data-holding subsystem 504. As the herein described methods and processes change the data held by the data-holding subsystem, and thus transform the state of the data-holding subsystem, the state of display subsystem 506 may likewise be transformed to visually represent changes in the underlying data. Display subsystem 506 may include one or more display devices utilizing virtually any type of technology. Such display devices may be combined with logic subsystem 502 and/or data-holding subsystem 504 in a shared enclosure, or such display devices may be peripheral display devices.

When included, communication subsystem 508 may be configured to communicatively couple computing system 500 with one or more other computing devices. Communication subsystem 508 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing system 500 to send and/or receive messages to and/or from other devices via a network such as the Internet.

Content module 514 may receive linear video content from a variety of sources, such as satellite, cable, over-the-airwaves broadcast, the Internet, etc. Content module 514 may be connected to one or more external tuners (not shown) that receive the linear video content and translate it into a format understandable by the computing system 500 (e.g., translate encrypted video into unencrypted MPEG 4). Content module 514 may also include an output configured to output the linear video content to the display subsystem 506.

Sensor subsystem 510 may include an input to receive from one or more sensors observation information indicating a natural user interface behavior of a viewer. In some embodiments, sensor subsystem 510 may include a depth camera.

Depth camera 512 may be a stereoscopic vision system including left and right cameras. Time-resolved images from both cameras may be registered to each other and combined to yield depth-resolved video.

In other embodiments, depth camera 512 may be a structured light depth camera configured to project a structured infrared illumination comprising numerous, discrete features (e.g., lines or dots). Depth camera 512 may be configured to image the structured illumination reflected from a scene onto which the structured illumination is projected. Based on the spacings between adjacent features in the various regions of the imaged scene, a depth map of the scene may be constructed.

In other embodiments, depth camera 512 may be a time-of-flight camera configured to project a pulsed infrared illumination onto the scene. The depth camera may include two cameras configured to detect the pulsed illumination reflected from the scene. Both cameras may include an electronic shutter synchronized to the pulsed illumination, but the integration times for the cameras may differ, such that a pixel-resolved time-of-flight of the pulsed illumination, from the source to the scene and then to the cameras, is discernable from the relative amounts of light received in corresponding pixels of the two cameras.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for awarding a user, comprising:
receiving a user-viewing goal detailing a specific linear video content viewing behavior of the user;
receiving one or more user-specific reports of all linear video content viewing behaviors of the user while using each of a plurality of different applications; and
granting an award to the user if the user-specific reports collectively indicate the user-viewing goal is reached by the user.

2. The method of claim 1, wherein the user-specific reports include viewing behaviors of the user across a plurality of devices.

3. The method of claim 1, where the award is an increase in a viewer score associated with the user.

4. The method of claim 1, where the award is an update to an avatar associated with the user.

5. The method of claim 1, wherein granting an award to the user further comprises authorizing unlocking of a previously locked award.

6. The method of claim 1, wherein the user-viewing goal comprises the user watching an episode of the linear video content.

7. The method of claim 1, wherein the user-viewing goal comprises the user watching an entire series of the linear video content, the series including a plurality of different episodes of the linear video content.

8. The method of claim 1, wherein the user-viewing goal comprises the user watching one or more commercials contained within the linear video content.

9. The method of claim 1, wherein the user-viewing goal comprises the user performing a specific action while watching the linear video content.

10. A method for awarding a user, comprising:
receiving notification from a promotional service of a user-viewing goal, the user-viewing goal detailing a specific linear content viewing behavior performable by a user;
sending to the promotional service one or more reports of linear content viewing behaviors performed by the user while using each of a plurality of different applications, the reports usable by the promotional service to determine if the user-viewing goal is met; and
receiving notification from the promotional service to grant an award to the user for meeting the user-viewing goal.

11. The method of claim 10, wherein the user-viewing goal is defined by one or more entities associated with the linear video content.

12. The method of claim 10, where the award is an increase in a viewer score associated with the user.

13. The method of claim 10, where the award is an update to an avatar associated with the user.

14. The method of claim 10, wherein the user-viewing goal comprises the user watching an episode of the linear video content.

15. The method of claim 10, wherein the user-viewing goal comprises the user watching an entire series of the linear video content, the series including a plurality of different episodes of the linear video content.

16. The method of claim 10, wherein the user-viewing goal comprises the user watching one or more commercials contained within the linear video content.

17. The method of claim 10, wherein the user-viewing goal comprises the user performing a specific action while watching the linear video content.

18. A data-holding subsystem holding instructions executable by a logic subsystem to:
receive a user-viewing goal detailing a specific linear video content viewing behavior of the user;
receive one or more user-specific reports of all linear video content viewing behaviors of the user while using each of a plurality of different applications; and
grant an award to the user if the user-specific reports collectively indicate the user-viewing goal is reached by the user.

19. The data-holding subsystem of claim 18, wherein the instructions are further executable to receive one or more user-specific reports from a plurality of devices.

20. The data-holding subsystem of claim 18, wherein the user-viewing goal is defined by one or more entities associated with the linear video content.
